(19) United States
(12) Patent Application Publication
(10) Pub. No.: US 2005/0075891 A1
(43) Pub. Date: Apr. 7, 2005

(54) Method and apparatus for bulk food marking and tracking

(76) Inventor: Vincent C. Arguimbau III, Darien, CT (US)

Correspondence Address: DAVID M QUINLAN, PC, 32 NASSAU STREET, SUITE 300, PRINCETON, NJ, 08542, US

(21) Appl. No.: 10/677,405

(22) Filed: Oct. 2, 2003

(51) Int. Cl. G06F 17/60

(52) U.S. Cl. 705/1; 705/8

(57) ABSTRACT

A method and apparatus for tracking and recording the processing of food products from the farm to the ultimate consumer, provides for recording each step on a central ledger, whereby the time, dates of manufacture, and manufacturers of all containers, including gathering baskets used to carry associated food products are tracked, along with crop pickers' names in association with their identified gathering baskets, the time and date of all manufacturing or processing and packing steps, and the identity of associated processors, packers, distributors, and wholesalers.

### FIELD OF THE INVENTION

The present invention is generally directed toward a method and apparatus for tracking the movement of food products from the farm to the ultimate consumer, and is more particularly directed toward tracking food products through all aspects of gathering, processing, and packaging operations for permitting subsequent tracing back through the operations to meet government regulations, commercial accounting requirements, and consumer reporting requirements.

### BACKGROUND OF THE INVENTION

Food producers, distributors, and retailers are increasingly required to implement systems for tracing all aspects of food production from the farm to the ultimate consumer. Much more stringent tracking or tracing requirements are being imposed upon importers of food products, and wholesalers and distributors of such food products, all under the regulatory control of the U.S. Food and Drug Administration (FDA). New and stricter regulations are being imposed under the Bio-terrorism Act of 2002. A recent requirement of the FDA is that systems must be implemented for tracing food products back to their source, preferably back to the farm where the food products were grown. Accordingly, presently available systems must be modified, or new systems designed, in order to meet the regulatory requirements.

### SUMMARY OF THE INVENTION

An object of the invention is to provide an improved method and system for tracking the movement of food products from the farm, through processing and packaging, through the distribution chain from the wholesaler, to the distributor and the ultimate consumer.

Another object of the invention is to provide an improved method and system for tracking the movement of food products from the farm, through processing and packaging, through the distribution chain from the wholesaler, to the distributor, to the ultimate consumer.

Another object of the invention is to provide a food tracking method and system that includes a centralized database for maintaining centralized ledgers for tracking uniquely identified food products from the farm to the ultimate consumer.

Yet another object of the invention is to provide a computerized method and system for tracking liquid or liquid-suspended and other food products through gathering, processing, and packaging steps, in a manner permitting rapid identification of crop pickers, gathering baskets, containers, manufacturers of the baskets and containers, distributors and processors, involved in growing or raising the food products, processing and packaging and distributing and selling the food products, for meeting all governmental, accounting, and informational requirements.

With these objects and problems in the prior art in mind, the present invention provides for tracking the manufacture and implementation of food gathering baskets, of pickers who may gather food or of automated equipment used for picking crops, of containers for moving and shipping the food products, of manufacturers producing the gathering baskets and shipping containers, respectively, and of the movement of food products from one location to another between the farm, processing facilities, and the entire distribution chain. All aspects of the movement of the food products are tracked on a central ledger associated with a centralized database. The central ledger is utilized to provide a permanent record for the tracking of food products from the farm through the conversion thereof into final products for sale. The system further provides means for using the ledger to track the cost of various steps in the food processing chain and distribution system, and for permitting companies to periodically audit the tracking system to ensure the accuracy of the data. Farmers and companies involved in the food processing chain or system may pay a fee to become members of the tracking system, and be provided with means for ensuring that their activities are properly recorded in the centralized ledger. The tracking system provides for means to label all containers involved in the processing, including food gathering baskets, automated picking equipment, and so forth, which are permanently labeled with unique codes that can be scanned to individually identify and track use of the same. Users of this system are provided with means for applying labels to the containers with the unique identifying codes imprinted on the labels. Scanning means are provided to scan labels for obtaining digitized data indicative of the date, time, and user of each container or basket.

In one embodiment of the invention users of the system are each provided with a unique numbering generator associated with a container label maker, for providing a printed label with a unique number for identifying the container, whereby for each label produced the user's account would be charged. The labels are applied to the containers and/or associated pallets through the entire food processing system. New tracking labels are applied to pallets loaded with a plurality of relatively small containers, and are applied to relatively large containers when repacked. In this manner, means are provided via scanning, date and time marking the labels, along with other data for tracking and tracing back every step in the food processing system, including the manufacture of containers and food gathering baskets, crop pickers, wholesalers, distributors, and retailers. Container labels are date and time stamped every time there is a change in the utilization of the container, such as when it is empty, filled, emptied, and/or moved from one location to another.

### BRIEF DESCRIPTION OF THE DRAWINGS

Various embodiments of the present invention are described below in association with the drawings, in which like items are identified by the same reference numeral, wherein:

FIG. 1 is a simplified block diagram showing one embodiment of the invention.

### DETAILED DESCRIPTION OF THE PREFERRED EMBODIMENTS

In one embodiment of the invention, a centralized database is maintained in a computer system for tracking all events from farm to retailer relative to the handling, processing, packaging, and movement of food products. In one aspect of the system, the various producers of food products from farmer to processor, manufacturers of containers and/or food gathering baskets, distributors, retailers, and others involved in the food chain, pay a fee to join a service providing centralized tracking of all processing and distribution of food products from the originating farm to the consumer. Each of the user members are provided with label makers having unique number generators for printing labels for permanent application to food gathering baskets, shipping containers, and so forth. Labels placed on the containers provide scannable printed information uniquely identifying each container. The labels are then scanned for identifying the manufacturer of the container, the time and date of manufacture, the present location of the container and so forth. When a container is filled with a food product, its label is scanned for identifying the food product, the farm where food product was produced, and the time and date of filling the container. The information is entered into a central ledger.

Every time a container is moved from one location to another in the food processing chain, its label is scanned for identifying the new location of the container and the date and time of transfer. The user may scan the label with a bar code reader, for example, and the information read is used to update the inventory data associated with the user, and also is transferred for updating a ledger maintained by the centralized computer for tracking all relevant information and movement of the associated food product. All transactions associated with the food product are tracked in this manner, and include farmer identification, picker or food gatherer identification, gathering basket identification, and transit shipping from one point to another, receipt of the container and food product by user, filling of a container with product, dumping a product from a container, the loss of a container and its product, and dates of time and sampling of a food product for testing, test results. The centralized ledger also provides for receiving data or notes for clarifying particular actions, for entry into a comment field associated with particular information obtained from scanning a label. In other words, the information provided in the ledger can be used to identify the source and history of the contained food product at any point in the food processing chain, for example, from an original processing tank to a shipping drum, followed by transfer to a final retail container, such as would be the case for tracking food products suspended in liquid.

The centralized ledger can also be used to provide data points from which an accounting system can record the transformation data useful for the tracking of raw material inventory as it is converted to final product inventory. Such tracking can also include cost factors, in order to provide user companies an opportunity to ensure the accuracy of the data, and also to determine whether improvements can be made in the processing for increasing the throughput of the food processing, and reducing costs. As indicated, the system integrity is maintained through ensuring that unlabeled containers at a particular user location are labeled, and time and date stamped at a user's premises upon receipt, for showing that such containers are in the inventory of that particular user.

In another embodiment of the invention, the present system provides for issuing to a user a label maker having associated with it a unique number generator, for generating a label that uniquely identifies a particular container. In one approach, a user's account is charged every time such a label is printed. More specifically, label charges may be imposed for each printing of a label at a container manufacturer, and at user facilities during tracking of unlabeled food products, such as when pallets containing quantities of containers are re-packed, and the pallets themselves labeled.

The label would preferably comprise a scannable bar code, and below the bar code an alphanumeric depiction of the bar code. The unique number generator could also include error-checking digits as part of the bar code, so that system software can immediately determine the integrity of the number read from the label. If the number's integrity is not verified, then a new label is printed and attached to the container. It is then scanned, with a notation of the number on the discarded label being manually inputted by an operator using the alphanumeric portion of the label.

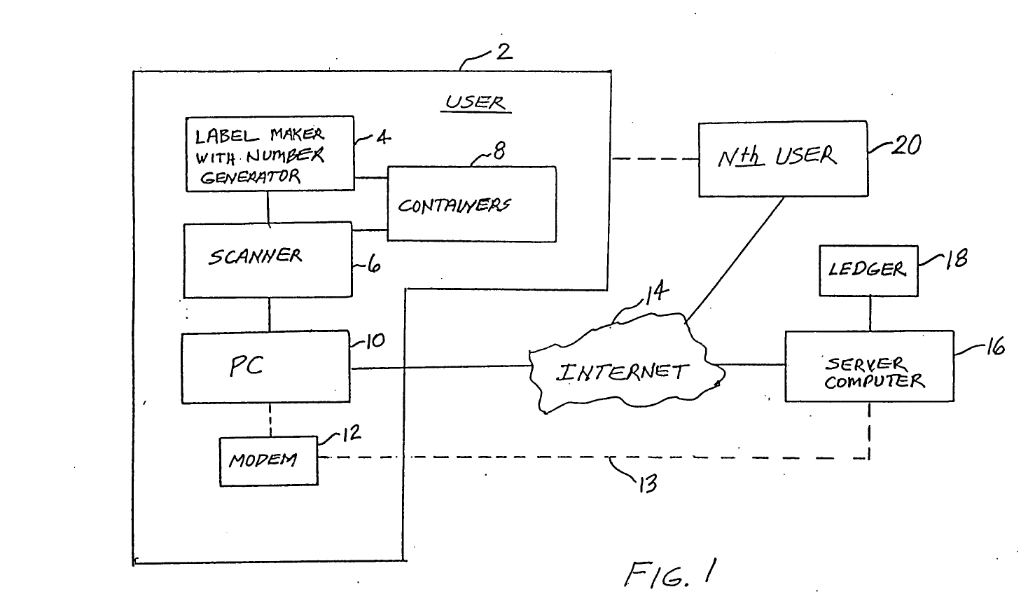

With reference to FIG. 1, a simplified block diagram is shown with a system for one embodiment of the invention. A typical user 2 of the present system and method, upon paying an initial fee to the system provider, receives a label maker 4 that includes a number generator, for imprinting scannable unique numbers or codes on the labels. The user 2 must also obtain a scanner 6, whereby the labels after application are scanned for permitting the information contained thereon to be inputted into a personal computer 10, in this example. The scanned information may be directly used by users 2 to update their inventory control for adding new containers 8 received, and for deleting containers 8 that are shipped from a user's facility to another user downstream in the system in the food processing stream. The personal computer 10 may be connected to the Internet 14 for transferring scanned information to the system provider's server computer 16, for example, for permitting the provider to update a central ledger 18 maintaining a record of all movement of the food product and associated containers through the food processing chain. In an alternative embodiment, the personal computer 10 may be connected through a modem 12 and a dedicated or a secure telephone line 13 to the server computer 16 of the provider. A plurality of users can be serviced by the system provider, as indicated by the Nth user 20. The various components shown for implementation of the system and associated method by a user 2 are not meant to be limiting, and other components or devices may be used for carrying out the methodology of the present system.

An example of one embodiment of the invention for carrying out the associated method for tracking of food products from the farm through the processing chain to the consumer and/or for tracking the processing and/or distribution of food products imported into a given country, the United States in this example, includes the following steps:

1. Manufacturers of crop picker food gathering baskets (not shown) permanently label each basket upon manufacture with a scannable unique code or number uniquely identifying each respective basket.

2. Manufacturers scan labels of all baskets produced to record time and date of manufacture and the manufacturer's name, and each basket is registered as being in a manufacturer's inventory, the registration being made on local databases, and in a ledger 18 maintained in a centralized database at the system provider's location for tracking all information obtained from the label scanning.

3. Manufacturers of large shipping containers 8, including but not limited to storage tanks, flexible bag tanks, steel drums, plastic drums, bulk collection baskets, and so forth, at time of manufacture permanently label each container 8 with a scannable unique code identifying the container.

4. Manufacturers of large containers scan all labels to register locally and in the centralized ledger the large containers' placement into a manufacturer's inventory, the date and time of manufacture, and the identity of the manufacturer.

5. Manufacturers of small containers 8 including but not limited to glass jars and tin cans, at time of manufacture group the containers as part of a pallet load, and label the pallets with permanent labels imprinted with a scannable code uniquely identifying the respective pallets.

6. Manufacturers of small containers 8 scan labels on pallets to date and time mark, and register locally and on the centralized ledger 18, the pallet loads of containers that are being placed into the associated manufacturer's inventory.

7. When empty large containers 8 and/or food gathering baskets are taken from a respective manufacturer's inventory for shipment to a distributor, for example, the labels on the containers and/or baskets are scanned for obtaining date and time marks for operating a personal computer 10 via a database program to produce a packing list for the shipment of the containers 8 and/or baskets, in addition to providing the scanned information for automatically reducing the respective manufacturer's inventory, and updating the central ledger 18.

8. When a distributor receives new large containers 8 and/or gathering baskets, labels are scanned for date and time marking the containers 8 and/or baskets, and for providing data to update the distributor's inventory, and the central ledger 18. Similarly, when the containers 8 and/or baskets are removed from the distributor's inventory for shipping to an end user, labels are scanned when loaded into the transport vehicle, for providing data indicating the date and time of shipment relative to each associated container 8 and/or basket, and for producing a packing list for the shipment, while at the same time reducing the distributor's inventory for the particular containers 8 and/or baskets shipped. The same scanned data is provided to the server computer 16 for updating the central ledger 18.

9. Upon receipt of the empty containers 8 and/or baskets, the labels on the containers and/or baskets are scanned for time and date stamping, and the data is provided to update the end user packer's inventory, and the central ledger 18.

10. At the beginning of the food gathering process, a farmer must ensure that labels of gathering baskets received from a distributor are scanned for the date and time marking, and for recording the name of the crop picker to whom each gathering basket is provided for picking the food products, whereby the scanned data is used for updating the farmer's inventory, and for updating the central ledger 18.

11. When a crop picker returns a full basket of food products for a transfer to shipping containers, the basket labels are scanned for dating and time marking the receipt of a particular basket, and the data is transmitted to the server computer 16 for updating the ledger 18 to show the product gathered in each particular basket, and the identity of the farm and the crop picker associated with the food product gathered, along with any other required information.

12. When a full basket's food product is transferred to a larger container 8, the labeling on the basket is scanned for time and date marking the product transferred, and for including a note regarding the destination to which the large containers 8 of the food product are to be shipped. For example, the larger container may be a food processing tank that is itself labeled with date and time markings, and scanned for providing data to the farmer's personal computer 10 for updating the farmer's inventory listing, and for transferring the data to the server computer 16 for updating the central ledger 18.

13. Intermediate food processors may remove labeled empty drums from inventory, to a production line where the labels of the drums are scanned for date and time stamping or marking, and for obtaining data showing the number and identification of the production line, and the food product to be loaded into the associated drum. The associated computer program will then operate the intermediate processor's personal computer 10 for reducing the intermediate processor's inventory of food product and drums, as appropriate, and for supplying the data for updating ledger 18.

14. The intermediate processor next delivers the filled drums for introduction of the contained food product onto a production line for further processing, at which time each container is labeled and scanned for time and date marking the event of so transferring the food product, for providing data for reducing the intermediate processor's inventory of food product, and for identifying the processing line associated with the next processing step. The data is also provided for updating the centralized ledger 18.

15. If the intermediate processor is to add ingredients to the food products being processed, then previous to doing so, the intermediate processor must ensure that the containers 8 carrying the ingredients were labeled upon receipt at the intermediate processor's facility, and the labels scanned for date and time stamping or marking, updating the packer's raw materials inventory, and transmitting the associated data into the system for updating ledger 18. Subsequent to such labeling and scanning, the ingredients and their associated containers 8 can then be moved to the processing line. After the ingredients have been added to the food products, in this example, the further processed food is delivered to containers, the container labels are scanned for showing date and time marking or stamping, and identifying the ingredients added and the source thereof, and for providing data to update ledger 18.

16. Samples of the food product may be randomly selected from containers 8 at any point in the food processing chain for laboratory and quality control analysis. The container 8 for each sampling has its label scanned for date and time marking, and for identifying the container from which the food product sampling was taken. The obtained data is transmitted for updating ledger 18.

17. The filled food product containers 8, such as drums for example, after filling, have their labels scanned for further identifying the source or sources of the associated food product, and for noting the transfer of the semi-processed food products into the intermediate processor's inventory. The scanned data is provided for updating ledger 18.

18. When the containers 8 of semi-processed food products are removed from the inventory of the intermediate processor, the associated labels are scanned for time and date marking, for creating a packing list, for reducing the intermediate processor's inventory of semi-processed goods, as the semi-processed food containers are loaded onto the shipping vehicle, and for updating ledger 18.

19. The containers are delivered to a final packer's facility, where the labels are scanned for marking upon receipt for obtaining data to update the inventory of the final packer, and for updating ledger 18. Any sampling or inspection of the food product in any of the drums is performed along with label scanning for date and time stamping or marking the drums for recording such samplings and inspections, and for updating the ledger 18.

20. The final packer scans the labels of the drums for date and time stamping or marking as the drums are delivered for initiating final packing of the food product. The identification number of the packing line is included with the data during scanning of the labels, for providing data for updating the inventory listing of the final packer, and for updating ledger 18, whereafter the associated drums are recorded as being removed from the semi-processed inventory of the final packer.

21. Empty palletized containers of glass jars, for example, are introduced to the final packing line via scanning of labels for dating and time marking. This scanned data is provided for reducing the final packer's inventory of packaging material, and for updating ledger 18.

22. The glass jars, in this example, are inkjet coded at the time of filling with food product via the final packing line, and filled and closed. The inkjet coding will include information permitting tracking via the ledger 18 of the food product contained therein back, through all of the chain of food processing, to the farm.

23. After the jars have been packed with the food product, such as olives and olive oil, for example, the jars are packed in appropriate cartons, and palletized. After a pallet is completely packed with cases of the processed product, a label is created from the label maker 4 with a unique number printed thereon for identifying the pallet, and the time and date marking. The label is scanned, and the data obtained is used to update ledger 18. At this point in the processing, the ledger will show all of the codes of all of the jars located on the associated pallet. The scanned data is also used by the final packer for updating his inventory of packed and palletized processed food product to show an appropriate increase therein.

24. When the pallets of end-processed food products are removed from inventory for shipping, the labels on the pallets are scanned with date and time stampings and scanned for obtaining data for creating a packing list, reducing the inventory of the final packer, and for updating ledger 18. The final product inventory of the final packer is thereby reduced.

25. At this point, the computerized system stores via ledger 18 the historical tracking from the farm originating the food products, to the packaging of the food products in individual containers, for permitting tracking of the food products through the entire food processing chain. Accordingly, a consumer by merely identifying the product purchased via the inkjet code on the glass jar, in this example, can utilize this code for tracing the food product back through the food chain to the farm, as indicated. The unique numbering and/or coding system utilized by the present invention permits accurate tracing or back tracking of all events associated with the food product from the farm through to delivery to the consumer.

26. P2P (Peer-To-Peer) programming is used in one embodiment of the invention to correlate different databases that may be used by participants in the present tracking process. The process requires its use throughout the entire product processing steps, including use of the unique numbering system printed on labels applied to containers, pallets, drums, and so forth.

Although various embodiments of the invention have been shown and described herein, they are not meant to be limiting. Those of skill in the art may recognize certain modifications to these embodiments, which modifications are meant to be covered by the spirit and scope of the appended claims. For example, the methodology of the present invention has been described and illustrated in association with tracking food products that may be suspended in liquid, or in which the food products themselves may be liquid. However, the present method and system for tracking food products is not meant to be so limited, and can with alteration be applied for use for tracking food products that are otherwise packaged.

1. A method for tracking and recording the processing of food products from the farm to the ultimate consumer, said method comprising the steps of:
providing a label maker with a number generator for printing a scannable unique code or number upon a label, for producing uniquely encoded labels as required;
applying permanent labels onto a plurality of food gathering baskets located on the premises of the food gathering organization, each label being coded for uniquely identifying each basket and the associated manufacturer, each label being provided through use of said label maker; and
scanning the respective labels on said baskets when distributed to crop pickers, for recording on said ledger the name of the crop picker assigned a particular basket, along with other information printed on the label, and date and time marking.

2. The method of claim 1, further including the step of scanning the labels on each full crop gathering basket returned by a crop picker to a receiving station of the associated gathering organization, for date and time marking the receipt, and updating the ledger to show each such receipt, the crop picker's identification, and noting the product, farm source, and any other required data, along with removing the crop picker's name from assignment of the basket.

3. The method of claim 2, further including the steps of:
labeling processing tanks with a permanent unique identification number or code; and
scanning the labels on each full gathering basket at the time of dumping its food product into a receiving processing tank or container, for date and time marking the dumping, noting the destination of the tank or container, and updating the ledger.

4. The method of claim 3, further including the steps of:
applying to every relatively large container a permanent label imprinted with a scannable unique code or number, said label to be applied at the time of manufacture, for uniquely identifying each container throughout their entire period of use;
scanning a label after application to a container, for date and time marking the manufacture of the container, and identifying the manufacturer; and
registering data obtained in said scanning step into a central ledger for recording placement of the container into the inventory of the associated manufacturer, and maintaining a permanent record of the history of the container, including its manufacturer and use.

5. The method of claim 4, further including the step of scanning the labels for date and time marking all labeled containers at each station or point in the process for converting raw food product into a final packaged product, and for updating the ledger with the scanned data.

6. The method of claim 4, further including the step of scanning labels of empty drums or containers delivered by intermediate processors to a production line, to provide date and time marking of each drum along with the associated production line number and product identification of product to be loaded into an associated drum, the scanned and included data being used to reduce the intermediate packer's inventory of packaging materials, and update the central ledger.

7. The method of claim 6, further including the steps of:
moving processing tanks filled with product to be processed to a production line, for emptying product onto the production line; and
scanning labels of emptied processing tanks for time and date marking associated product dumping events, for obtaining data to identify product delivered to the production line, reduce the intermediate packer's inventory of filled processing tanks, marking the products association with a particular production line, and updating said ledger.

8. The method of claim 7, further including the steps of:
applying to every unlabeled container, if any, containing ingredients to be added to product during processing; and
scanning labels of containers carrying ingredients to date and time mark each, and to indicate the amount of said respective ingredients that are to be added to product, respectively.

9. The method of claim 7, further including the steps of:
scanning the labels on empty large containers to be shipped to distributors as they are loaded onto transport vehicles for date and time marking each container for updating said ledger to reduce the associated manufacturer's inventory, and to produce a packing list for the associated shipment; and
scanning the labels on empty said large containers at the time of delivery to a distributor for date and time marking them, adding them into the distributor's inventory, and updating said ledger.

10. The method of claim 9, further including the steps of:
scanning the labels on empty said large containers at the time of loading onto a transport vehicle for shipment from the distributor to an end user packer, for date and time marking to both produce a packing list, and reduce the distributor's inventory, along with updating said ledger; and
scanning the labels on empty large containers upon delivery to an end user packer, for both registering the containers into the packer's unfinished inventory, and updating said ledger.

11. The method of claim 10, further including the steps of:
scanning labels of filled containers or drums after filling to identify their source product, introduce the same into the intermediate packer's inventory, and update said ledger, for the semi-processed product; and
scanning labels of containers of semi-processed product as they are loaded onto transport vehicles for creating a packing list, reducing the intermediate packer's inventory of semi-processed product, and updating said ledger.

12. The method of claim 11, further including the step of scanning the labels of the semi-processed product drums or containers when delivered to a final packer's facility, for date and time marking, and adding the same to the final packer's inventory, and updating said ledger.

13. The method of claim 12, further including the step of scanning the labels of any semi-processed product drums or containers randomly selected for inspection or sampling, for date and time marking, and adding to said ledger.

14. The method of claim 12, further including the step of scanning the labels of drums or containers of semi-processed product for date and time marking when they are delivered to a final packer, for updating said ledger along with a notation of the pack line number, and for removing the associated drums or containers from semi-processed inventory.

15. The method of claim 13, further including the step of scanning the labels of drums or containers of semi-processed product for date and time marking when they are delivered to a final packer, for updating said ledger along with a notation of the pack line number, and for removing the associated drums or containers from semi-processed inventory.

16. The method of claim 14, further including the steps of:
applying to any pallet loaded with a plurality of relatively small containers, a permanent label imprinted with a scannable unique code or number, said label to be applied at the time of loading each said pallet(s), for uniquely identifying each said pallet(s) as used in association with said plurality of relatively small containers;
scanning the label on each said pallet(s), for date and time marking the loading of the pallet, identifying the relatively small containers, and their manufacturer; and
registering data obtained in said step of scanning each pallet label into said ledger, for date and time marking the loading of a pallet, identifying the containers, and their manufacturer, and for recording placement of the pallet(s) with associated containers into the inventory of the associated manufacturer.

17. The method of claim 16, further including the step of scanning the labels of pallets carrying relatively small containers for date and time marking the pallet label when brought to the pack line, and using the scanned data to reduce an inventory of packaging materials.

18. The method of claim 17, further including the step of removing any shrink wrap and labels from said pallets.

19. The method of claim 18, further including the step of printing coded information on said small containers at the time of filling them with product and sealing the containers.

20. The method of claim 19, further including the steps of:
casing and palletizing the small containers as they exit an associated packing line;
applying a new label with unique identifying number to each said pallet when loaded with finalized product in small containers; and
scanning the new labels on associated loaded pallets for date and time marking, updating said ledger with the scanned data and all of the codes on said small containers carried by each said pallet, and increasing the inventory of the packer for packed palletized filled product.

21. The method of claim 20, further including the step of scanning the labels of pallets carrying filled product containers for date and time marking at the time of loading the palletized containers onto transport vehicles for shipment to wholesalers, for creating a packing list, reducing the final packers inventory of finished product, noting the wholesaler to receive the products, and updating said ledger.

22. The method of claim 20, further including the steps of:
selecting on a random basis, filled containers of either one of source product or packed product;
sampling product from said randomly selected containers for laboratory and quality control analysis; and
scanning labels of said randomly selected containers for date and time marking, and adding comments, all for entry into said ledger for recording the analysis events.

23. The method of claim 20, further including the step of correlating associated user databases for reporting from said ledger the tracking of said product from raw material to final packed product.

24. The method of claim 23, wherein said correlating step further includes using P2P programming to provide the correlation.

25. A method for tracking and recording the production of food products from farms where the food products are grown, through the entire food processing chain to the consumer, said method comprising the steps of:
applying to every relatively large container a permanent label imprinted with a scannable unique code or number, said label to be applied at the time of manufacture, for uniquely identifying each container throughout their entire period of use;
scanning a label after application to a container, for date and time marking the manufacture of the container, and identifying the manufacturer;
applying to any pallet loaded with a plurality of relatively small containers, a permanent label imprinted with a scannable unique code or number, said label to be applied at the time of loading each said pallet(s), for uniquely identifying each said pallet(s) as used in association with said plurality of relatively small containers;
scanning the label on each said pallet(s), for date and time marking the loading of the pallet, identifying the relatively small containers, and their manufacturer;
applying permanent labels onto a plurality of food gathering baskets located on the premises of the food gathering organization, each label being coded for uniquely identifying each basket and the associated manufacturer; and
scanning the respective labels on said baskets when distributed to crop pickers, for recording on said ledger the name of the crop picker assigned a particular basket, along with other information printed on the label, and date and time marking.

26. The method of claim 25, further including the step of registering data obtained in said scanning step into a central ledger for recording placement of the container into the inventory of the associated manufacturer, and maintaining a permanent record of the history of the container, including its manufacturer and use.

27. The method of claim 26, further including the step of registering data obtained in said step of scanning each pallet label into said ledger, for date and time marking the loading of a pallet, identifying the containers, and their manufacturer, and for recording placement of the pallets(s) with associated containers into the inventory of the associated manufacturer.

28. The method of claim 26, further including the steps of:
scanning the labels on empty large containers to be shipped to distributors as they are loaded onto transport vehicles for date and time marking each container for updating said ledger to reduce the associated manufacturer's inventory, and to produce a packing list for the associated shipment; and
scanning the labels on empty said large containers at the time of delivery to a distributor for date and time marking them, adding them into the distributor's inventory, and updating said ledger.

29. The method of claim 28, further including the steps of:
scanning the labels on empty said large containers at the time of loading onto a transport vehicle for shipment from the distributor to an end user packer, for date and time marking to both produce a packing list, and reduce the distributor's inventory, along with updating said ledger; and
scanning the labels on empty large containers upon delivery to an end user packer, for both registering the containers into the packer's unfinished inventory, and updating said ledger.

30. The method of claim 26, further including the step of scanning the labels on each full crop gathering basket returned by a crop picker to a receiving station of the associated gathering organization, for date and time marking the receipt, and updating the ledger to show each such receipt, the crop picker's identification, and noting the product, farm source, and any other required data, along with removing the crop picker's name from assignment of the basket.

31. The method of claim 30, further including the steps of:
labeling processing tanks with a permanent unique identification number or code; and
scanning the labels on each full gathering basket at the time of dumping its food product into a receiving processing tank or container, for date and time marking the dumping, noting the destination of the tank or container, and updating the ledger.

32. The method of claim 31, further including the steps of:
scanning the labels for date and time marking all labeled containers at each station or point in the process for converting raw food product into a final packaged product, and for updating the ledger with the scanned data;
scanning labels of empty drums or containers delivered by intermediate processors to a production line, to provide date and time marking of each drum along with the associated production line number and product identification of product to be loaded into an associated drum, the scanned and included data being used to reduce the intermediate packer's inventory of packaging materials, and update the central ledger;
moving processing tanks filled with product to be processed to a production line, for emptying product onto the production line; and
scanning labels of emptied processing tanks for time and date marking associated product dumping events, for obtaining data to identify product delivered to the production line, reduce the intermediate packer's inventory of filled processing tanks, marking the products association with a particular production line, and updating said ledger.

33. The method of claim 32, further including the steps of:
applying labels having scannable unique codes to every unlabeled container, if any, containing ingredients to be added to product during processing, for uniquely identifying each container; and
scanning labels of containers carrying ingredients to date and time mark each, and to indicate the amount of said respective ingredients that are to be added to product, respectively.

34. The method of claim 33, further including the steps of:
selecting on a random basis, filled containers of either one of source product or packed product;
sampling product from said randomly selected containers for laboratory and quality control analysis; and
scanning labels of said randomly selected containers for date and time marking, and adding comments, all for entry into said ledger for recording the analysis events.

35. The method of claim 34, further including the steps of:
scanning labels of filled containers or drums after filling to identify their source product, introduce the same into the intermediate packer's inventory, and update said ledger, for the semi-processed product;
scanning labels of containers of semi-processed product as they are loaded onto transport vehicles for creating a packing list, reducing the intermediate packer's inventory of semi-processed product, and updating said ledger;
scanning the labels of the semi-processed product drums or containers when delivered to a final packer's facility, for date and time marking, and adding the same to the final packer's inventory, and updating said ledger;
scanning the labels of any semi-processed product drums or containers randomly selected for inspection or sampling, for date and time marking, and adding to said ledger; and
scanning the labels of drums or containers of semi-processed product for date and time marking when they are delivered to a final packer, for updating said ledger along with a notation of the pack line number, and for removing the associated drums or containers from semi-processed inventory.

36. The method of claim 35, further including the steps of:
scanning the labels of pallets carrying relatively small containers for date and time marking the pallet label when brought to the pack line, and using the scanned data to reduce an inventory of packaging materials;
removing any shrink wrap and labels from said pallets;
printing coded information on said small containers at the time of filling them with product and sealing the containers;
casing and palletizing the small containers as they exit an associated packing line;
applying a new label with unique identifying number to each said pallet when loaded with finalized product in small containers; and
scanning the new labels on associated loaded pallets for date and time marking, updating said ledger with the scanned data and all of the codes on said small containers carried by each said pallet, and increasing the inventory of the packer for packed palletized filled product.

37. The method of claim 36, further including the step of scanning the labels of pallets carrying filled product containers for date and time marking at the time of loading the palletized containers onto transport vehicles for shipment to wholesalers, for creating a packing list, reducing the final packers inventory of finished product, noting the wholesaler to receive the products, and updating said ledger.

38. The method of claim 37, further including the steps of:
using P2P programming to provide a computer program correlating associated databases for reporting from said ledger the tracking of said product from raw material to final packed product; and
permitting a consumer to identify a product via the code applied to the associated container, for the purpose of tracking the product's processing from a pallet received by a wholesaler back to the final packer, the intermediate packer, the crop picker, the basket used by the crop picker, the crop picker, and the farm where the product was grown.

39. The method of claim 37, wherein said food products are ultimately liquid or liquid suspended food products.

40. A system for tracking and recording the production of food products from farm to ultimate consumer, comprising:
a label maker including a unique number generator, for applying a scannable unique number on each label made, for permitting a user to produce a uniquely encoded label to be placed on any basket, container, or processing vessel used for containing or holding food over the entire production chain and process for the associated food product(s), each label being further encoded when applicable with information identifying farms, crop pickers, manufacturers, food product(s), and production lines;
a scanner for scanning each label as applied to a basket or any other container holding the associated food products, said scanner being utilized over each step involved in moving, transporting, transferring, or storing associated food products and/or associated containers or processing vessels, said scanner providing digitized signals representative of the information on each label scanned, and the date and time of scanning;
a personal computer (PC) responsive to the scanner, for reading the digitized label information into an associated memory;
a server computer remote for each user;
means for permitting a user to transmit from said memory of said PC to said server computer, the digitized information from each label scanning;
a central ledger for permanently storing the digitized label information received by said server computer; and
means for permitting a user to access the information stored on said central ledger.

41. The system of claim 40, wherein said transmit means includes connecting a user PC to said server computer via the Internet.

42. The system of claim 41, wherein said user access means includes connecting a user PC to said server computer via the Internet.

43. The system of claim 40, wherein said transmit means includes a modem connection between said PC and said server computer.

44. The system of claim 43, wherein said user access means includes a modem connection between said PC and said server computer.
